(19) United States
(12) Patent Application Publication
(10) Pub. No.: US 2019/0351447 A1
(43) Pub. Date: Nov. 21, 2019

(54) METHOD AND APPARATUS FOR COATING A SUBSTRATE

(71) Applicant: Acupac Packaging, Inc., Mahwah, NJ (US)

(72) Inventors: Walter A. Klauser, Ringwood, NJ (US); Michael J. Borja, Keyport, NJ (US); David C. Young, Norwood, NJ (US)

(21) Appl. No.: 16/196,494

(22) Filed: Nov. 20, 2018

Related U.S. Application Data
(60) Provisional application No. 62/589,689, filed on Nov. 22, 2017.

(51) Int. Cl. B05C 9/04; B05C 13/02

(52) U.S. Cl. CPC B05C 9/04; B05C 13/02

(57) ABSTRACT

The disclosed subject matter generally relates to methods and apparatus for coating opposing sides of a substrate simultaneously with a coating material. The disclosed subject matter also generally relates to apparatus for simultaneously applying a coating material to multiple sides of the substrate.

### CROSS-REFERENCE TO RELATED APPLICATIONS

The present application claims the benefit of priority to U.S. Provisional Patent Application No. 62/589,689, filed Nov. 22, 2017, which is incorporated herein by reference in its entirety.

### FIELD OF THE DISCLOSURE

The disclosure and disclosed embodiments generally relate to an apparatus and method for applying coating materials to a substrate.

### BACKGROUND

Currently the coating a web of material or substrate with a slot die, extruder or powder coater or dispenser is limited to applying the coating to one side of the substrate at a time. For example, the apparatus shown in FIG. 1 includes a conveyor belt 100 on which a substrate 102 is conveyed. A hopper 104 contains coating material 106 to be scattered and applied to substrate 102. Coating material 106 is applied using a knurled roller 108. The knurled roller 108, that include a plurality of projecting knobs or ridges 109 on the exterior thereof, is in contact with a brush belt 110. As the knurled roller 108 rotates and the conveyor belt moves in the direction of arrow 112, particles of the coating material 106 from the hopper are captured by the knurled roller 108 and when the entrapped particles 114 on knurled roller 108 encounter the brush belt 110, the entrapped particles become dislodged from the knurled roller 108, become released particles 116. As the released particle fall, they form a coating 118 on the substrate 102 as it moves. The apparatus can also include a cleaning roller 120 that may remove particles remaining on knurled roller 108 after it encounters brush belt 110. This apparatus is limited to coating a substrate on only one side of the substrate. If more than one side of the substrate needs to be coated, the substrate must be run a second time through the apparatus of FIG. 1 in which the side of substrate 102 that has not been coated in coated using the same apparatus. Such a process not only takes additional time, but also requires that the substrate be collected and passed through the apparatus a second time, a process that requires additional equipment as well as the risk of damage to the already coated side of the substrate.

Such coated substrates can be used in the manufacture of products, such as for example, facial cleansing wipes, bath and shower cleansing cloths, anti-static hair cloths, dry coated medical devices, facial masks, eye treatment cloths and dry coated stacked towels. It would be advantageous to coat a more than one side of a substrate in a single pass.

### SUMMARY

In one embodiment, a substrate coating apparatus is provided. The substrate coating apparatus includes an enclosure and a gate. The an enclosure includes an open top, an aperture positioned opposite to the open top and an interior. The gate is positioned adjacent to or in the aperture and includes an opening configured such that when the substrate passes through the opening, the surface of the substrate within the opening is in substantial contact and slidably engaged with the surface of the gate within the opening.

In another embodiment, coating apparatus for a substrate including a sheet of substrate material having opposing planar sides is provided. The substrate coating apparatus includes an enclosure and a gate. The enclosure includes an open top, an aperture positioned opposite to the open top and an interior. The gate is positioned adjacent to or in the aperture and includes a pair of elongated substantially linear gate members and an elongated substantially linear opening between the pair of elongated substantially linear gate members. The opening is configured such that when the substrate passes through the opening, the surface of each of the opposing planar sides of the substrate are in substantial contact and slidably engaged with one of the pair of gate members.

In another embodiment, coating apparatus for an elongated substrate having a surface along the linear axis of the substrate is provided. The substrate coating apparatus includes an enclosure and a gate. The enclosure includes an open top, an aperture positioned opposite to the open top and an interior. The substrate coating apparatus includes an enclosure and a gate. The gate is positioned adjacent to or in the aperture and includes an opening configured such that when the elongated substrate passes through the opening, the linear surface of the elongated substrate within the opening is in substantial contact and slidably engaged with the surface of the gate within the opening.

In another embodiment, a method for coating a substrate using a coating apparatus is provided. The substrate coating apparatus includes an enclosure and a gate. The enclosure includes an open top, an aperture positioned opposite to the open top and an interior. The gate is positioned adjacent to or in the aperture and includes an opening configured such that when the substrate passes through the opening, the surface of the substrate within the opening is in substantial contact and slidably engaged with the surface of the gate within the opening. The method includes inserting the substrate into the opening, adding coating material to the enclosure and passing the substrate through the enclosure and thereby coating it with the coating material.

In another embodiment, a method for coating a substrate using a coating apparatus, the substrate including a sheet of substrate material having opposing planar sides, is provided. The substrate coating apparatus includes an enclosure and a gate. The enclosure includes an open top, an aperture positioned opposite to the open top and an interior. The gate is positioned adjacent to or in the aperture and includes an opening configured such that when the substrate passes through the opening, the surface of the substrate within the opening is in substantial contact and slidably engaged with the surface of the gate within the opening. The method includes inserting the substrate into the opening, adding coating material to the enclosure and passing the substrate through the enclosure and thereby coating it with the coating material.

In another embodiment, a method for coating an elongated substrate having a surface along the linear axis of the substrate using a coating apparatus is provided. The substrate coating apparatus includes an enclosure and a gate. The enclosure includes an open top, an aperture positioned opposite to the open top and an interior. The substrate coating apparatus includes an enclosure and a gate. The gate is positioned adjacent to or in the aperture and includes an opening configured such that when the elongated substrate passes through the opening, the linear surface of the elongated substrate within the opening is in substantial contact and slidably engaged with the surface of the gate within the opening. The method includes inserting the substrate into the opening, adding coating material to the enclosure and passing the substrate through the enclosure and thereby coating it with the coating material.

### BRIEF DESCRIPTION OF THE DRAWINGS

These and other features, aspects, and advantages of the disclosure and disclosed embodiments will become better understood when the following detailed description is read with reference to the accompanying drawings in which like characters represent like parts throughout the drawings, wherein:

FIG. 1 is a schematic illustration of an apparatus for coating one side of a substrate;

FIGS. 2A and 2B are side perspective and cross-section views illustrating of one embodiment of a coating device;

FIG. 3A is a cross-section view illustrating bridging of a coating material in a hopper;

FIG. 3B is a cross-section view illustrating arching of a coating material in a hopper;

FIG. 3C is a cross-section view illustrating clinging of a coating material in a hopper;

FIG. 3D is a cross-section view illustrating ratholing of a coating material in a hopper;

FIG. 4 is a perspective view illustrating an embodiment of a ribbon roller or auger;

FIG. 5 is a perspective view illustrating an embodiment of a paddle-type roller or auger;

FIG. 6 is a perspective view illustrating an embodiment of a Z-form blade auger;

FIG. 7 is a schematic illustration of one embodiment of a coating system; and

FIGS. 8A and 8B are side perspective and top views illustrating of one embodiment of a coating device;

FIG. 9 is a side view of an embodiment of a divider;

FIGS. 10A and 10B are side perspective and top views illustrating of one embodiment of a coating device;

FIGS. 11A and 11B are side perspective and top views illustrating of one embodiment of a coating device; and

FIGS. 12A-12D are top views illustrating embodiments of gates.

### DETAILED DESCRIPTION

Detailed description of the methods and apparatus will be illustrated herein below. Unless defined otherwise, technical and scientific terms used herein have the same meaning as is commonly understood by one of ordinary skill in the art to which this disclosure belongs.

The term “a” or “an” “one” does not denote a limitation of quantity, but rather denote the presence of at least one of the referenced items. Approximating language, as used herein throughout the specification and claims, may be applied to modify any quantitative representation that could permissibly vary without resulting in a change in the basic function to which it is related. Accordingly, a value modified by a term or terms, such as “about” is not to be limited to the precise value specified. In some embodiments, “about” denote allowing the value modified in the range of plus or minus 10 percentages, like “about 100” denotes it can be any value between 90 and 100. Besides, in the term “about the first value to the second value”, the “about” modify both the first and second value. In some instances, the approximating language may correspond to the precision of an instrument for measuring the value.

Although the methods and apparatus will be described with reference to the drawings, it should be understood that the disclosed embodiments can be embodied in many alternate forms. In addition, any suitable size, shape or type of elements or materials could be used.

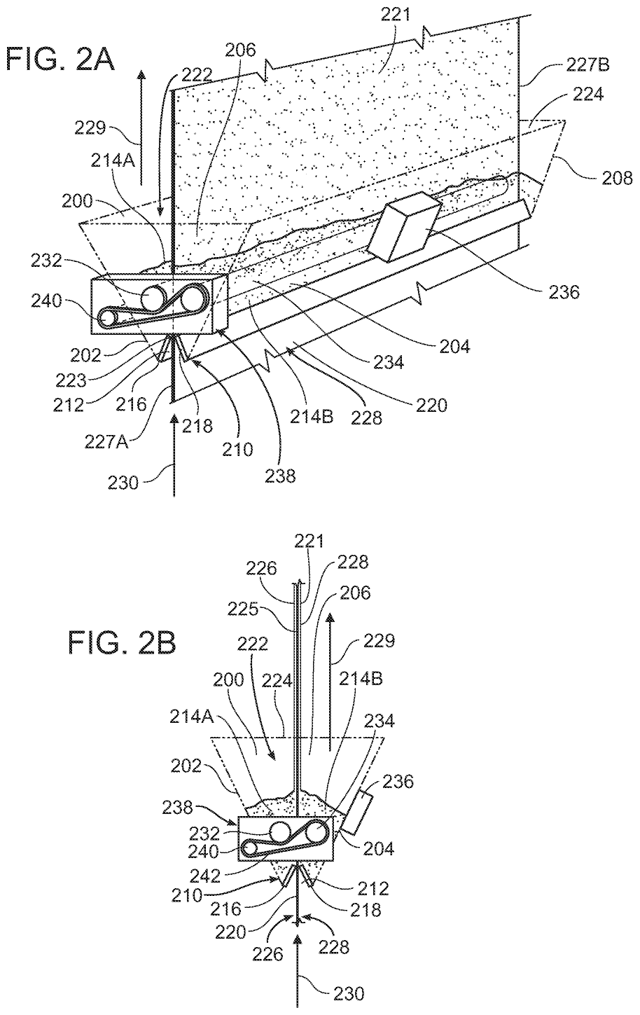

FIGS. 2A and 2B illustrate aspects of coating a substrate with an exemplary embodiment, including the method and apparatus included therein. The web of material or substrate may include, for example, a non-woven or woven fabric material, such as, for example, (e.g., cotton, hemp, rayon, polyester, cellulose acetate, polypropylene, polyethylene, polycarbonate, polyester, polyvinyl chloride) and films, such as, for example, water soluble films (e.g., sodium alginate, sodium carboxymethyl cellulose (sodium CMC), polyvinyl alcohol, polyvinyl pyrrolidone (PVP), xanthan, karaya gum, hydroxypropyl cellulose (HPC), hydroxypropyl methyl cellulose (HPMC), hydroxyethyl methyl cellulose (NEMC), gelatin, pectin and modified starch). The substrate may be in various geometric forms, including, for example, a substantially planar sheet or a narrower shape such as in the form of a cord or string (e.g., a single strand or braided strands with a generally round, generally polygon (e.g., triangular, quadrilateral, hexagonal, etc.) or generally flattened cross-section (e.g., rectangular)). The coating material may be an active or inactive compound including, for example, a particulate material, such as, for example, a powder material or combination of powder materials (e.g., corn starch, potato starch, rice starch, tapioca starch, flour, talc, clays and charcoal, for example, activated charcoal) or a liquid material or combination of liquid materials (e.g., surfactants (sodium lauryl sulfate), viscous liquids (gel), hemostatic liquids (kaolin clays solution, ferric subsulfate, aluminum sulfate). Examples of active compounds can include, for example, anesthetics such as anesthetics such as benzocaine, antifungals such as miconazole and clotrimazole and anti-bacterial such as bacitracin, neomycin, and polymyxin B. An example of a powder coating material may include combination of corn starch, activated charcoal and a fragrance.

The exemplary embodiment of FIGS. 2A and 2B includes an enclosure, such as, for example, hopper 200 having sides 202 and 204, end sections 206 and 208 and an aperture 210 with a generally inverted triangular shape. The hopper 200 may be made of metal, such as, for example, aluminum, stainless steel, steel, brass, titanium, etc, or polymer (i.e., plastic) such as acrylonitrile butadene styrene (ABS), poly(methyl methacrylate) (PMMA, i.e., plexiglass), poly(ethyl methacrylate) (PEMA), polyethylene, polypropylene, polyvinyl chloride (PVC), polystyrene, polyethylene terephthalate, polyethylene terephthalate, polycarbonate, polyurethane, styrene, styrene butadiene, polytetrafluoroethylene (PTFE), epoxy silicones, ethylene-vinyl acetate (EVA), melamine, nylon, polyacrylonitrile, etc. Preferably, sides 202 and 204 can be a clear polymer such as, for example, poly(methyl methacrylate) and end sections 206 and 208 can be aluminum such that the level of coating material can be monitored through the clear sides. The aperture 210 includes a gate 212 through which the web of material or substrate passes into the hopper 200 to be coated by coating material 214A and 214B. Gate 212 may be a one-way gate that includes gate members 216 and 218 that apply pressure to the surface of the substrate as it passes through gate 212. In this embodiment, gate members 216 and 218 are each elongated substantially linear structures, positioned in parallel on opposite sides of aperture 210. The gate members can be made of a material that can bend and have memory such as, example, metal including steel, stainless steel, low carbon steel, aluminum, brass, etc. or polymer including polyester, acrylic, polyvinyl chloride (PVC), polypropylene, polycarbonate, etc. The thickness of the gate members (i.e., the cross-sectional dimension of the gate member shown in FIG. 2B) may be from about 10/1000 to about 15/1000 of an inch. Although, gate members 216 and 218 may both be a flexible material, or one of the two gate members may be a rigid or less flexible material than the other gate member such that after web of material or substrate 220 passes through gate 212 and into the interior 222 of hopper 200 to be coated by coating material 214A and 214B, gate members 216 and 218 having an opening 223 therebetween, the opening 223 having a size or dimension such that substrate 220 slidably engages and is in substantial contact with gate members 216 and 218 when passing through opening 223 to substantially provide a seal and to substantially prevent passage of coating material 214A and 214B from hopper 200 through gate 212. In the embodiment of FIGS. 2A and 2B, opening 223 is an elongated substantially linear opening suitable for receiving a planer sheet of substrate material. This results in substrate 220 having coatings 221 and 225 applied thereto. Edges 227A and 227B of substrate 220 can also be slidably engaged with the interior of hopper end section 206 and 208 such that passage of coating material 214A and 214B from one side of substrate 220 to the other is minimized, particularly if the coating materials are different. Such passage of coating material can also be minimized during the coating process when substrate 220 is moving in the direction of arrow 229.

It is preferable that the measurements of the hopper components and gate components for all the embodiments disclosed herein be substantially matched to one another and the substrate to provide substantially perfect sitting of the components resulting in a fit that minimizes leakage.

Hopper 200 may be positioned in a generally vertical position with an open top 224 positioned higher than aperture 210 such that coating material 214A and 214B is positioned in interior 222 adjacent to gate 212. In this embodiment, substrate 220 is a substantially planer sheet with opposing sides 226 and 228. As substrate 220 passes through gate 212, it proceeds into interior 222 of hopper 200 with opposing sides 226 and 228 simultaneously encountering coating material 214A and 214B and becoming coated therewith and exits hopper 200 through open top 224. In some embodiments coating material 214A and 214B are the same material where opposing sides 226 and 228 are coated with the same material. In other embodiments, coating material 214A and 214B are different materials where opposing sides 226 and 228 are coated with different materials. The path of travel in the direction of arrow 229 through interior 222 of hopper 200 may preferably be along a substantially vertical axis 230 from gate 212, through open top 224 such that opposing sides 226 and 228 simultaneously encountering coating material 214A and 214B and become coated therewith thereby resulting in substrate 220 having coated sides 226 and 228. The angle of the path of travel can vary relative the substantially vertical axis 230 as long as opposing sides 226 and 228 simultaneously encountering coating material 214 and becoming coated therewith. Gate members 216 and 218 can also be useful in preventing substrate 220 from being pulled in a direction opposite to the path of travel shown by arrow 229. Substrate 220 can be either pushed or pulled through the embodiment of FIGS. 2A and 2B during the coating process.

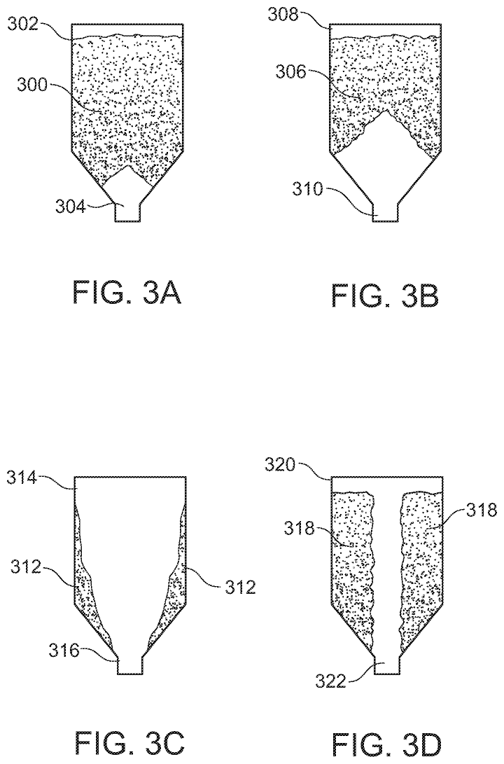

Hopper 200 may also include devices to break up coating material 214A and 214B in the hopper and minimize undesirable process conditions, such as, for example, bridging, arching, clinging or ratholing of coating material 214A and 214B inside the hopper, particularly if coating material 214A and 214B is a particulate material, such as, for example, a powder material. Conditions such as bridging, arching, clinging or ratholing should be avoided and can lead to coatings of unacceptable quality. Such devices may also help “push” coating material 214A and 214B, particularly a particulate material such as for example a powder against the substrate 220 as it passes through hopper 200 and can aid in its even application to substrate 220. FIG. 3A illustrates bridging of coating material 300 in hopper 302 having an aperture 304. FIG. 3B illustrates arching of coating material 306 in hopper 308 having an aperture 310. FIG. 3C illustrates clinging of coating material 312 in hopper 314 having an aperture 316. FIG. 3D illustrates ratholing of coating material 318 in hopper 320 having an aperture 322.

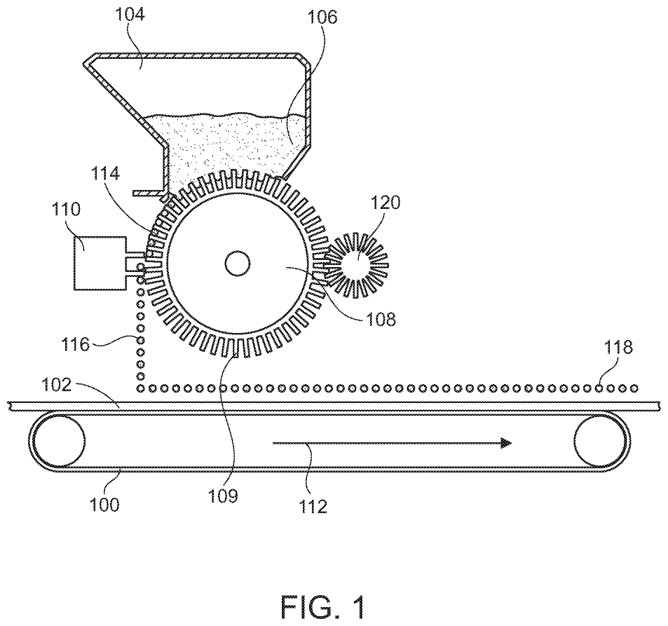

Such coating material breakup devices may include one or more of at least two knurled rollers 232 and 234 or a pneumatic or electric vibratory apparatus 236 for this embodiment, with a roller on each side of substrate 220. Each of the knurled rollers 232 and 234 can be similar to knurled roller 108 in FIG. 1 having projecting knobs or ridges on the exterior surface thereof. The two knurled rollers 232 and 234 are positioned on the interior 222 of hopper 200 proximate to gate 212 or at a level such that rotation thereof provides substantial breakup of the coating material 214A and 214B as described above. Knurled rollers 232 and 234 are located on opposing sides of substrate 220 with knurled roller 232 preferably rotating clockwise and knurled roller 234 preferably rotating counterclockwise. Knurled rollers 232 and 234 may be driven by an external drive apparatus 238. External drive apparatus 238 may include a drive motor 240 that is connected to knurled rollers 232 and 234 via belt 242. In this embodiment, knurled rollers 232 and 234 preferably rotate in opposite directions such that knurled roller 232 rotates clockwise and knurled roller 234 rotates counterclockwise and the configuration of belt 242 imparts such intended motion to knurled rollers 232 and 234

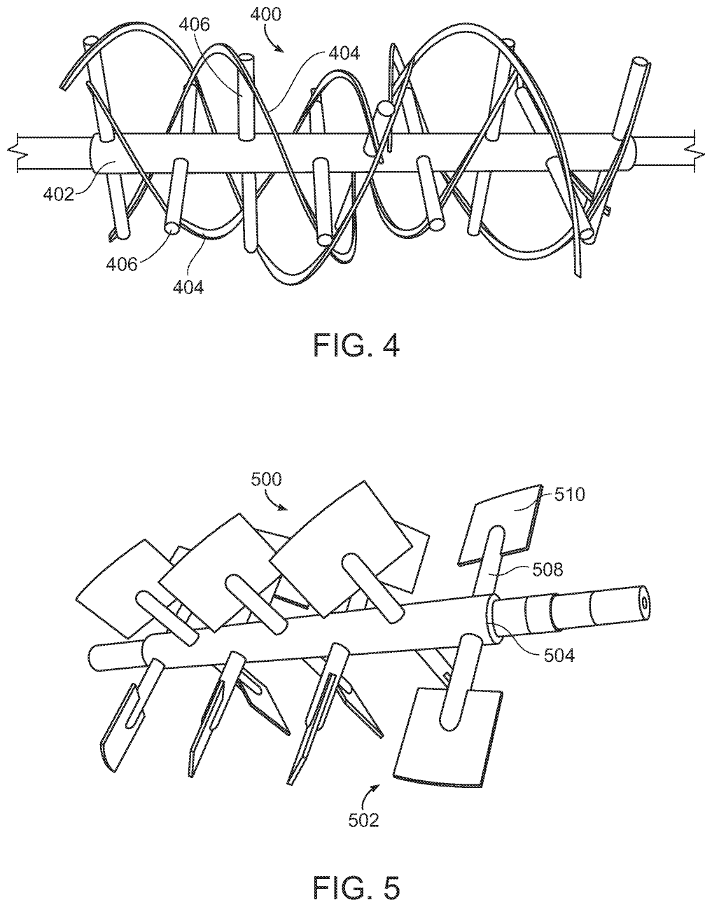

In other embodiments, a pair of ribbon rollers or augers may be used in place of gnarled rollers 232 and 234. One embodiment of such a ribbon roller or auger is shown in FIG. 4. Ribbon roller or auger 400 may include a shaft 402 with at least one ribbon section 404 of a helical configuration connected thereto via arm sections 406, preferably a plurality of helical ribbon sections, more preferably a plurality of helical ribbon sections with at least two sections configured in helical opposition to one another. Each ribbon roller or auger can be positioned in hopper 200 similarly to gnarled rollers 232 and 234 and driven by a similar drive apparatus.

In other embodiments, a pair of paddle-type rollers or augers may be used in place of gnarled rollers 232 and 234. One embodiment of such a paddle-type roller or auger is shown in FIG. 5. Paddle-type roller or auger 500 may include a plurality of paddles sections 502 connected to a shaft 504. Each paddle section 502 may include an arm section 508 connected to shaft 502 at one end and a paddle 510 at the other end. Each paddle-type roller or auger can be positioned in hopper 200 similarly to gnarled rollers 232 and 234 and driven by a similar drive apparatus.

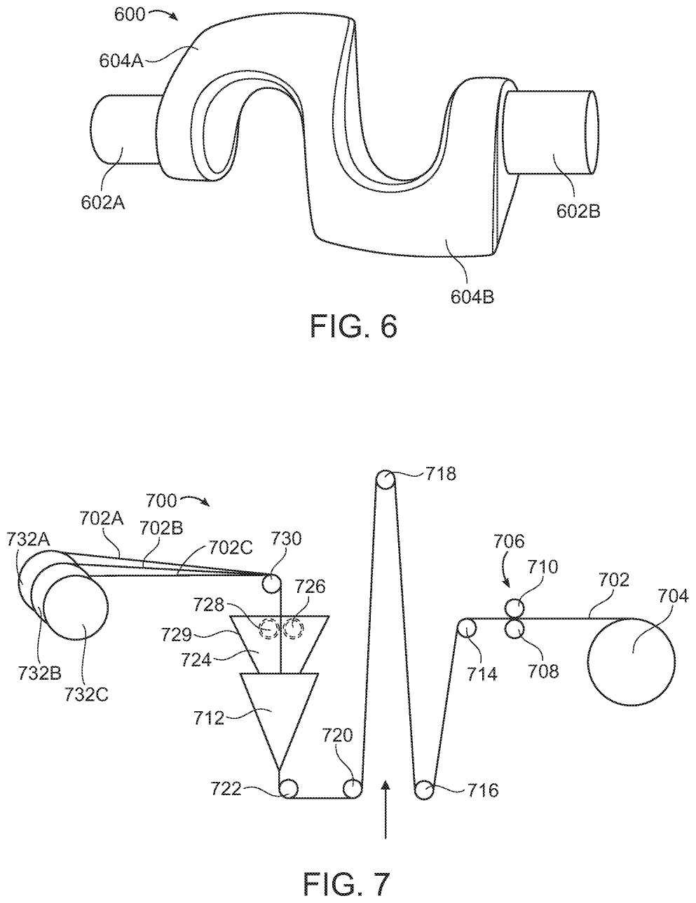

In other embodiments, a pair of Z-form blade augers may be used in place of gnarled rollers 232 and 234. One embodiment of such a Z-form blade auger is shown in FIG. 6. Z-form blade auger 600 may include shaft sections 602A and 602B with blades 604A and 604B connected thereto. Each Z-form blade auger can be positioned in hopper 200 similarly to gnarled rollers 232 and 234 and driven by a similar drive apparatus. Vibratory apparatus 236 may be located on the exterior of at least one of sides 202 and 204 and end section 206 and 208, preferably closer to aperture 210 in order to maximize the vibratory forces exerted on coating material 214.

A coating device, such as the embodiments included here and exemplified in FIG. 2, may be incorporated into coating system, an embodiment of which is illustrated in FIG. 7. In FIG. 7, coating system 700 includes a supply of web of material or substrate 702, such as for example, a roll 704 of substrate material 702. The substrate material may be fed through a solution coating station 706. Solution coating station 706 may include, for example, a pair of rollers 708 and 710 and can be used to apply a solution, such as, for example, polyols including, for example, glycerin, propylene glycol and butylene glycol and oils, for example, including mineral oil, glycerol fatty acid esters and caster oils to both sides of the substrate 702, the solution intended to aid in the adhesion of the coating material applied at coating station 712. Substrate 702 may then pass through roller 714 and to an accumulation-wicking station including, for example, rollers 716, 718 and 720. The accumulation-wicking station allows the solution imparted to substrate 702 at solution coating station 706 to wick and penetrate the substrate. After passing roller 722, substrate 702 passes through coating station 712. An embodiment such a coating station is illustrated in FIGS. 2A and 2B, as well as illustrated by other embodiments included in the present disclosure. After leaving coating station 712 with both sides of substrate 702 coated with coating material, the coated substrate passes to a brushing station 724. Brushing station 724 may include brushes 726 and 728 in enclosure 729, the brushes preferably rotate such that brush 726 rotates clockwise and brush 728 rotates counterclockwise. Enclosure 729 is of a generally inverted triangular shape. Brushing station 724 preferably results in an even layer of coating material on the substrate and is preferably positioned above coating station 712 such that excess coating material removed in brushing station 724 deposits back into coating station 712 to be reapplied. The speed of brushes 726 and 728 may be used to control the amount of loading of the coating material on substrate 702. For example, the slower the speed of brushes 726 and 728 can result in a greater amount of loading of coating material than a faster speed. As an alternative to brushes 726 and 728, other embodiments may include air knives, air waves (e.g., sonic) squeegees, vibratory blades, or anti-static or electrostatic devise to accomplish the same purpose. After brushing station 724, substrate 702 passes through a slitter 730 to divide substrate 702 into multiple sections, for example 702A, 702B and 702C that are then gathered using, for example, a motor driven apparatus, such as for example, motor driven rollers 732A, 732B and 732C, respectively, that gather sections 702A, 702B and 702C as well as move the substrate material through coating system 700 in general and coating station 712. The motor driven apparatus can use, for example, electric motors.

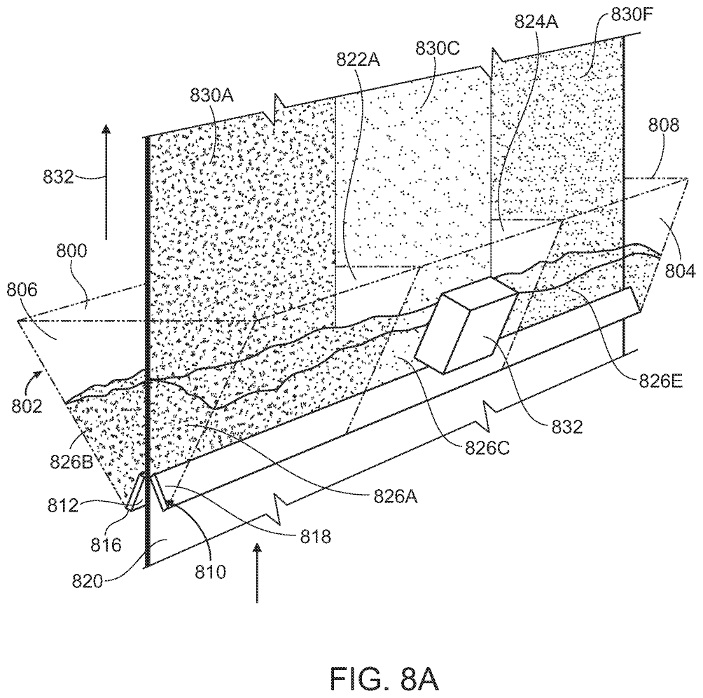

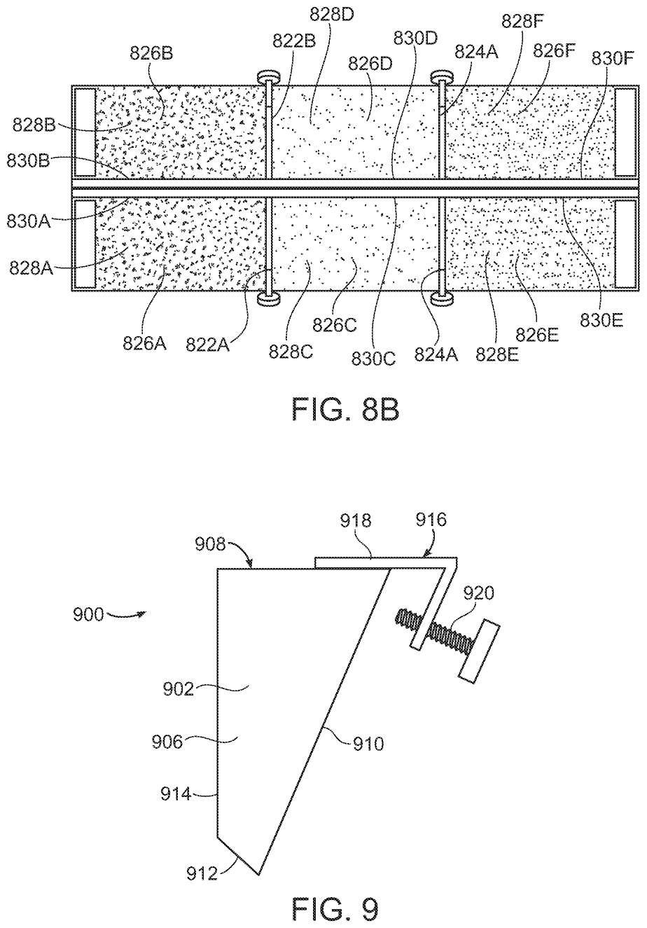

The exemplary embodiment of FIGS. 8A and 8B is similar to the embodiment of FIGS. 2A and 2B and includes hopper 800 having sides 802 and 804, end section 806 and 808 and an aperture 810 with a generally inverted triangular shape. The aperture 810 includes a gate 812 through which the web of material or substrate passes into the hopper 800 to be coated by coating material. Gate 812 may be a one-way gate that includes gate members 816 and 818 that apply pressure to the surface of the substrate 820 as it passes through gate 812. The embodiment of FIGS. 8A and 8B provides for coating substrate 820 with multiple coating materials along the width thereof. This embodiment includes dividers 822A, 822B, 824A and 824B that separate hopper 800 for this embodiment into three different sections that can contain different coating material. Dividers 822A and 822B are positioned on opposing sides of substrate 820 and directly opposite one another. However, such dividers can be positioned on opposite sides and in a staggered relationship to one another. The number of dividers on one side of substrate 820 need not be the same as are on the opposite side. The number of sections such dividers can separate the hopper into is not limited to three and can be a few as two and more than three. As with the embodiment of FIGS. 2A and 2B, for each hopper section formed by the dividers, the coating material on one side of the substrate can be the same or different from the coating material on the opposite side of the substrate. In this embodiment, for example, coating material 826A and 826B in hopper sections 828A and 828B coat sides 830A and 830B of substrate 820, coating material 826C and 826D in hopper sections 828C and 828D coat sides 830C and 830D of substrate 820 and coating material 826E and 826F in hopper sections 828E and 828F coat side 830E and 830F of substrate 820. Coating material breakup devices may include one or more vibratory apparatus 832 that may be located on the exterior of at least one of sides 802 and 804 and end section 806 and 808, preferably closer to aperture 810 in order to maximize the vibratory forces exerted on the coating material. Knurled rollers used in the embodiment of FIGS. 2A and 2B are not used in this embodiment because of dividers 822A, 822B, 824A and 824B.

An embodiment of dividers 822A, 822B, 824A and 824B is included in FIG. 9. Divider 900 includes a divider wall 902 and an attachment arm connected to the divider wall 902. The divider wall 902 is substantially planer with opposing sides 906 and 908 and edges 910, 912 and 914. The divider wall 902 can be made of a material that is easy to fabricate into the desired shape of the divider wall, such as metal including for example, aluminum, stainless steel, steel, brass, titanium, etc. or preferably polymer (i.e., plastic) including, for example acrylonitrile butadiene styrene (ABS), poly(methyl methacrylate) (PMMA, i.e., plexiglass), poly(ethyl methacrylate) (PEMA), polyethylene, polypropylene, polyvinyl chloride (PVC), polystyrene, polyethylene terephthalate, polyethylene terephthalate, polycarbonate, polyurethane, styrene, styrene butadiene, polytetrafluoroethylene (PTFE), epoxy silicones, ethylene-vinyl acetate (EVA), melamine, nylon, polyacrylonitrile, etc. Sides 906 and 908 encounter the coating material on either side of the divider wall 902. Edge 910 is positioned against the interior of a side of the enclosure containing the coating material and of an angle to match the slope of the side, for example, side 804 shown in FIG. 8A. Edge 912 is positioned against a gate member, for example gate member 818 in FIG. 8A. Edge 914 is positioned against the substrate which is slidably engaged with divider so that the substrate can proceed in the path of travel in the direction of arrow 832, such as for example, substrate 820 in FIG. 8A and 8B. Edges 910, 912 and 914 are positioned as above to substantially prevent passage of coating material from one side of divider 900 to the other side of the divider. Coating material from one side of the divider is substantially prevented from passing from one side of the divider to the other via edge 914 in part because of the measurements of the divider being substantially matched to the measurements of the hopper and the substrate to provide substantially perfect sitting of the components resulting in a fit that minimizes leakage from one side of the divider to the other. Also, leakage is minimized in part because of the upward movement of the substrate during the coating process.

Divider also includes an attachment device 916 connected to the divider wall 902 to attached it to the hopper. Attachment device 916 and components that make it up can be made of substantially rigid material such as metal including for example, aluminum, stainless steel, steel, brass, titanium, etc. The attachment device 916 includes an arm 918 with a locking screw 920 that can be rotatably moved in and out to contact the out of the side of the hopper where the divider in positioned and secure it thereto.

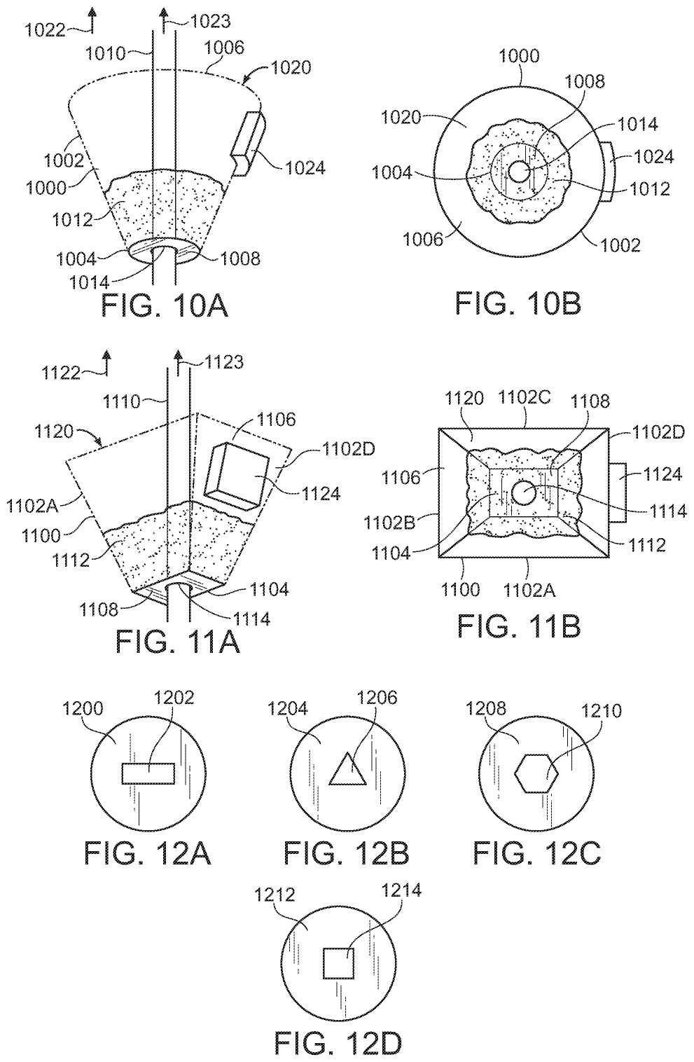

Another embodiment of the present disclosure is in FIGS. 10A and 10B which can be used to apply a coating material to an elongated substrate such as a string or cord of substrate material having a surface along the linear axis of the substrate. The embodiment of FIGS. 10A and 10B will have a vertical cross-section similar to FIG. 2B. The exemplary embodiment of FIGS. 10A and 10B includes an enclosure, such as, for example, hopper 1000 with a generally inverted cone and a triangular shape, a side 1002 with a generally circular horizontal cross-section, an aperture 1004 and an open top 1006. The aperture 1004 includes a gate 1008 through which an elongated substrate 1010 passes into the hopper 1000 to be coated by coating material 1012. Gate 1008 includes an opening 1014 that may be a one-way gate that applies pressure to the surface of the substrate 1010 as it passes through the gate. Gate 1008 may a flexible material such that substrate 1010 passes through gate 1008 and into the interior of hopper 1000 to be coated by coating material 1012 with pressure applied to substrate 1010 by gate 1008 due to its flexibility. Opening 1014 has a size or dimension such that substrate 1010 slidably engages and is in substantial contact with gate 1008 when passing through opening 1014 to substantially provide a seal and to substantially prevent passage of coating material 1016 from hopper 1000 through gate 1008. Exemplary materials that can be used for the hopper 1000 and the gate 1008 are the same as the hopper and gate members included above for the embodiment FIGS. 2A and 2B.

Hopper 1000 may be positioned in a generally vertical position with open top 1006 positioned higher than aperture 1004 such that coating material 1012 is positioned in interior 1020 adjacent to gate 1008. As substrate 1010 passes through gate 1008, it proceeds through hopper 1000 encountering coating material 1012 becoming coated therewith and exits hopper 1000 through open top 1006 in a coated state, similar to the process used in the FIGS. 2A and 2B embodiment. The path of travel in the direction of arrow 1022 through interior 1020 of hopper 1000 may preferably be along a substantially vertical axis 1023 (also the linear axis of the elongated substrate shown in the figure) from gate 1008 through open top 1006 The angle of the path of travel can vary relative the substantially vertical axis 1023. Gate 1008 can also be useful in preventing substrate 1010 from being pulled in a direction opposite to the path of travel shown by arrow 1022. Substrate 1010 can be either pushed or pulled through the embodiment of FIGS. 10A and 10B during the coating process.

Hopper 1000 may also include devices to break up coating material 1012 in the hopper and minimize undesirable process conditions, such as, for example, bridging, arching, clinging or ratholing of coating material 1012 inside the hopper, particularly if coating material 1012 is a particulate material, such as, for example, a powder material. Such coating material breakup devices may include a pneumatic or electric vibratory apparatus 1024 for this embodiment on side 1002.

Another embodiment of the present disclosure is in FIGS. 11A and 11 B which can be used to apply a coating material to an elongated substrate such as a string or cord of substrate material having a surface along the linear axis of the substrate. The embodiment of FIGS. 11A and 11B will have a vertical cross-section similar to FIG. 2B. The exemplary embodiment of FIGS. 11A and 11 B includes an enclosure, such as, for example, hopper 1100 with a generally inverted pyramid shape and a polygon shape in horizontal cross-section, sides 1102A, 1102B, 1102C and 1102D, an aperture 1104 and an open top 1106. The aperture 1104 includes a gate 1108 through which an elongated substrate 1110 passes into the hopper 1100 to be coated by coating material 1112. Although this generally pyramid shaped hopper includes 4 sides, other embodiments can include at least 3 sides as well as more than 4 sides. Gate 1108 includes an opening 1114 that may be a one-way gate that applies pressure to the surface of the substrate 1110 as it passes through the gate. Gate 1108 may a flexible material such that substrate 1110 passes through gate 1108 and into the interior of hopper 1100 to be coated by coating material 1112 with pressure applied to substrate 1110 by gate 1108 due to its flexibility. Opening 1114 has a size or dimension such that as substrate 1110 and is in substantial contact with gate 1108 when passing through opening 1114 to substantially provide a seal and to substantially prevent passage of coating material 1112 from hopper 1100 through gate 1108. Exemplary materials that can be used for the hopper 1100 and the gate 1108 are the same as the hopper and gate members included above for the embodiment FIGS. 2A and 2B.

Hopper 1100 may be positioned in a generally vertical position with an open top 1106 is positioned higher than aperture 1104 such that coating material 1112 is positioned in interior 1120 adjacent to gate 1108. As substrate 1110 passes through gate 1108, it proceeds through hopper 1100 encountering coating material 1112 becoming coated therewith and exits hopper 1100 through open top 1106 in a coated state, similar to the process used in the FIGS. 2A and 2B embodiment. The path of travel in the direction of arrow 1122 through interior 1120 of hopper 1100 may preferably be along a substantially vertical axis 1123 (also the linear axis of the elongated substrate shown in the figure) from gate 1108, through open top 1106. The angle of the path of travel can vary relative the substantially vertical axis 1123. Gate 1108 can also be useful in preventing substrate 1110 from being pulled in a direction opposite to the path of travel shown by arrow 1122. Substrate 1110 can be either pushed or pulled through the embodiment of FIGS. 11A and 11B during the coating process.

Hopper 1100 may also include devices to break up coating material 1112 in the hopper and minimize undesirable process conditions, such as, for example, bridging, arching, clinging or ratholing of coating material 1112 inside the hopper, particularly if coating material 1112 is a particulate material, such as, for example, a powder material. Such coating material breakup devices may include a pneumatic or electric vibratory apparatus 1124 for this embodiment on at least one of sides 1102A, 1102B, 1102C and 1102D.

The cross-section shape of gate opening 1014 in the FIGS. 10A and 10B embodiment and gate opening 1114 in the FIGS. 11A and 11B embodiment is generally round for substrates that are generally round in cross-section. For substrates coated using the embodiments of FIGS. 10A and 10B and 11A and 11B, the shape of these openings preferably has a cross-section to generally match the cross-section of the substrate being coated. FIGS. 12A, 12B, 12C and 12D include exemplified openings for other shapes, however, these are only examples and are not limiting. If the substrate has a generally flattened rectangular cross-section, the gate 1200 in FIG. 12A may have an opening 1202. If the substrate has a generally triangular cross-section, the gate 1204 in FIG. 12B may have an opening 1206. If the substrate has a generally hexagon cross-section, the gate 1208 in FIG. 12C may have an opening 1210. If the substrate has a generally square cross-section, the gate 1212 in FIG. 12D may have an opening 1214.

Another embodiment is a method of using the embodiments included in the present disclosure. The method includes inserting the substrate into the opening of the gate, in some embodiments through the gate into the interior of the hopper and in some additional embodiments above the intended level of the coating material in hopper. Next the coating material is added to the hopper and the substrate is pulled from beyond the open top of the hopper or pushed from below the aperture of the hopper to progressively pass the substrate through the hopper and thereby coating it with the coating material.

This written description uses examples as part of the disclosure, including the best mode, and also to enable any person skilled in the art to practice the disclosed implementations, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A substrate coating apparatus, comprising
a. an enclosure including
i. an open top;
ii. an aperture positioned opposite to the open top; and
iii. an interior
b. a gate positioned adjacent to or in the aperture, the gate including an opening configured such that when the substrate passes through the opening, the surface of the substrate within the opening is in substantial contact and slidably engaged with the surface of the gate within the opening.

2. The substrate coating apparatus of claim 1, wherein the substrate is a sheet.

3. The substrate coating apparatus of claim 1, wherein the substrate is an elongated substrate.

4. The substrate coating apparatus of claim 1, wherein the enclosure is oriented in a substantially vertical position.

5. The substrate coating apparatus of claim 1, wherein the enclosure has a substantially inverted triangle shape in cross-section.

6. The substrate coating apparatus of claim 1, wherein the gate is a one-way gate.

7. The substrate coating apparatus of claim 1, wherein the gate applies pressure to the surface of the substrate as it passes through the gate.

8. The substrate coating apparatus of claim 1, further including a coating material breakup device.

9. The substrate coating apparatus of claim 1, further including a divider to separate the enclosure into sections.

10. A coating apparatus for a substrate including a sheet of substrate material having opposing planar sides, the coating apparatus comprising
a. an enclosure including
i. an open top;
ii. an aperture positioned opposite to the open top; and
iii. an interior
b. a gate positioned adjacent to or in the aperture, the gate including a pair of elongated substantially linear gate members and an elongated substantially linear opening between the pair of elongated substantially linear gate members, the opening configured such that when the substrate passes through the opening, the surface of each of the opposing planar sides of the substrate are in substantial contact and slidably engaged with one of the pair of gate members.

11. The substrate coating apparatus of claim 10, wherein the gate is a one-way gate.

12. The substrate coating apparatus of claim 10, wherein at least one of the pair of gate members is flexible to apply pressure to the surface of the substrate as it passes through the gate.

13. The substrate coating apparatus of claim 10, further including a coating material breakup device.

14. The substrate coating apparatus of claim 10, further including a motor driven apparatus to move the substrate through the gate.

15. A coating apparatus for an elongated substrate having a surface along the linear axis of the substrate, the coating apparatus comprising
a. an enclosure including
i. an open top;
ii. an aperture positioned opposite to the open top; and
iii. an interior
b. a gate positioned adjacent to or in the aperture, the gate including an opening configured such that when the elongated substrate passes through the opening, the linear surface of the elongated substrate within the opening is in substantial contact and slidably engaged with the surface of the gate within the opening.

16. The substrate coating apparatus of claim 15, wherein the opening is substantially circular in shape.

17. The substrate coating apparatus of claim 15, wherein the opening is substantially rectangular in shape.

18. The substrate coating apparatus of claim 15, wherein the opening is substantially triangular in shape.

19. The substrate coating apparatus of claim 15, wherein the gate is flexible to apply pressure to the surface of the substrate within the opening.

20. The substrate coating apparatus of claim 1, further including a coating material breakup device.
